(19) United States
(12) Patent Application Publication
(10) Pub. No.: US 2024/0351904 A1
(43) Pub. Date: Oct. 24, 2024

(54) METHOD FOR PREPARING HYDROPHOBIC COPPER NANOCLUSTERS-CONTAINING COLLOIDAL SOLUTION AND USE OF HYDROPHOBIC COPPER NANOCLUSTERS-CONTAINING COLLOIDAL SOLUTION IN DETECTING Fe3+

(71) Applicant: Shandong University, Jinan (CN)

(72) Inventors: Xia XIN, Jinan (CN); Zhicheng WANG, Jinan (CN); Di SUN, Jinan (CN); Shanshan ZHANG, Jinan (CN)

(21) Appl. No.: 18/305,599

(22) Filed: Apr. 24, 2023

(51) Int. Cl. C01G 3/04; B82Y 15/00; G01N 21/64

(52) U.S. Cl. CPC C01G 3/04; B82Y 15/00; G01N 21/6428; C01P 2006/90

(57) ABSTRACT

Disclosed are a method for preparing a hydrophobic copper nanoclusters-containing colloidal solution and use of the hydrophobic copper nanoclusters-containing colloidal solution in detecting Fe³⁺. The hydrophobic copper nanoclusters-containing colloidal solution is prepared by dissolving Cu₄I₄ in dimethyl sulfoxide to obtain a solution of Cu₄I₄ in DMSO, and then performing self-assembly of the solution of Cu₄I₄ in DMSO with a EuW₁₀ solution.

### TECHNICAL FIELD

The present disclosure relates to a method for preparing a hydrophobic copper nanoclusters-containing colloidal solution and use of the hydrophobic copper nanoclusters-containing colloidal solution in detecting Fe³⁺, belonging to the field of new materials.

### BACKGROUND

Iron is an essential trace element in the human body and has a total content of about 4 to 5 g. Hemoglobin in red blood cells is a carrier to transport oxygen. Iron is a component of hemoglobin, combines with oxygen, and transports oxygen to every part of the body for the breathing and oxidization of human body to provide energy and obtain nutrition. Iron can also promote upgrowth, increase disease resistance, regulate tissue respiration, prevent fatigue, form heme, prevent and treat anemia caused by iron deficiency, and restore good skin color. However, excessive iron storage in the body also has potentially harmful effects, leading to iron poisoning. Iron poisoning is associated with a variety of diseases, such as heart and liver diseases, diabetes, and certain tumors. In addition, if there is too much iron in water, it will affect the color, smell, and taste of water and even affect special industries, such as textile, paper-making, and food industries. Therefore, it is necessary to study a convenient, rapid, simple, and easy-to-observe method for detecting iron, and the method has a great application prospect.

Fluorescent substances are often selected as fluorescent probes to detect toxic substances, and the principle lies in that the interaction between the substance to be detected and the fluorescent substance affects the luminescence of the fluorescent substance, so as to achieve the purpose of detection. Metal nanoclusters have unique luminescence phenomena due to their ligand-metal charge transfer, metal-metal interaction, and π-π stacking interaction between ligands, so metal nanoclusters can be used as fluorescent probes to detect toxic substances.

Copper nanoclusters are favored by practitioners because of their special properties and wide raw material sources, which have also been reported by patent documents. For example, CN108707644A (Application number: CN201810523133.5) discloses a method for detecting pyrophosphate ions and alkaline phosphohydrolases based on DNA-templated copper cluster probes. The method comprises: using DNA as a template to synthesize a copper cluster probe that emits red fluorescence, and then realizing the high sensitivity and high selectivity detection of pyrophosphate ions and alkaline phosphohydrolase through a fluorescent copper cluster nanoswitch initiated by Cr³⁺ ions. In addition, the fluorescent nano-probe can also realize the detection of pyrophosphate ions and alkaline phosphohydrolase in complex systems. For another example: CN113466199A (Application number: CN202110760412.5) discloses a method for preparing a composite fluorescent sensor of copper nanoclusters and diatomite for the detection of hexavalent chromium ions. The method comprises the following steps: 1) dissolving a copper salt in deionized water, ultrasonically dissolving at room temperature to form a uniformly mixed solution to obtain a solution A, wherein a ratio of the molar amount of the copper salt to the volume of deionized water is (0.12) mmol: (12) mL; 2) adding the solution A obtained in step 1) into a penicillamine solution, and stirring by a magnetic stirrer for 1-2 hours to obtain a solution B; and 3) adding diatomite into the solution B to obtain the composite fluorescence sensor of copper nanocluster and diatomite with hexavalent chromium ion detection function. However, there is no report of copper nanoclusters in the detection of iron ions.

Regarding the detection of iron ions, there are also reports from patent documents. For example, CN113460996A discloses a method for preparing a fluorescent carbon dot, hydrogel, and test paper for detecting iron ions. The carbon dot can be selectively combined with iron ions, which makes it be used for detecting iron ions in aqueous solutions and various biological systems. CN113376129A discloses a method for preparing carbon dots-based nanocomposites for detecting iron ions and use thereof. The carbon dots-based nanocomposites show excellent phosphorescence afterglow properties in a water environment and can be used for detecting iron ions in a water environment by phosphorimetry. CN113024595A discloses a fluorescent probe of 3,5,7-trimethylcyclotetrasiloxane ciprofloxacin for detecting trivalent iron ions. The ciprofloxacin modified with 1,3,5,7-tetramethylcyclotetrasiloxane has bright green fluorescence, and fluorescence quenching occurs when Fe³⁺ ions appear, thereby realizing the detection of Fe³⁺. However, the existing fluorescent probes for iron ion detection technology have not only complicated preparation methods but also exhibits worse in environmental protection.

### SUMMARY

For the shortcomings of the prior art, a method for preparing a hydrophobic copper nanoclusters-containing colloidal solution and use of the hydrophobic copper nanoclusters-containing colloidal solution in detecting Fe³⁺ are provided. In the present disclosure, the colloidal solution has a simple preparation method, no pollution, and great detection sensitivity, and is highly economical.

### DEFINITION OF TERMS

Cu₄I₄ refers to a kind of tetranuclear copper nanocluster with triphenylphosphine as a ligand. Due to π-π interaction between ligands, charge transfer interaction from ligand to metal, charge transfer interaction from ligand to metal-metal, and metal-metal interaction, Cu₄I₄ has weak luminescence properties, but the quantum yield of Cu₄I₄ is close to zero.

EuW₁₀ refers to Na₉[Euw₁₀O₃₆]·32H₂O), which is a kind of Weakley-type rare earth-polyoxometalate, contains rare earth elements in its molecule, has charge transfer interaction from ligand to metal, and has certain luminescent properties.

The present disclosure provides the following technical solutions:

A hydrophobic copper nanoclusters-containing colloidal solution, which is prepared by mixing a solution of Cu₄I₄ in an organic solvent with an aqueous solution of EuW₁₀.

According to some embodiments of the present disclosure, a volume ratio of the solution of Cu₄I₄ in an organic solvent to the aqueous solution of EuW₁₀ is in a range of (3-5):6, and preferably 4:6.

According to the present disclosure, in some embodiments, the organic solvent is dimethyl sulfoxide (DMSO).

According to the present disclosure, in some embodiments, a concentration of Cu₄I₄ in dimethyl sulfoxide is in a range of 0.0025-5 mg·mL⁻¹. In some embodiments, a concentration of EuW₁₀ in water is in a range of 2-3 mg·mL⁻¹.

According to the present disclosure, in some embodiments, after mixing, in the hydrophobic copper nanoclusters-containing colloidal solution, a total concentration of EuW₁₀ is in a range of 1-2 mg·mL⁻¹ and a total concentration of Cu₄I₄ is in a range of 0.001-3 mg·mL⁻¹.

According to the present disclosure, in some embodiments, Cu₄I₄ is prepared by a process comprising:
dispersing CuI in a dichloromethane solution, and stirring to be uniform, adding triphenylphosphine thereto, and fully stirring at room temperature, to obtain a first mixture; and subjecting the first mixture to suction filtration to obtain a white powdery solid; and
adding the white powdery solid into an excessive acetonitrile solution, performing ultrasonic treatment to disperse the white powdery solid in an excessive acetonitrile solution to be uniform, removing excessive CuI, to obtain a second mixture, and subjecting the second mixture to suction filtration, to obtain a crude solid product, washing the crude solid product with acetonitrile, to obtain a first solid powder, dissolving the first solid powder in a dimethyl sulfoxide solution, standing for layering to obtain an upper layer, and adding dropwise a methanol solution to the upper layer and diffusing for three days, to obtain the Cu₄I₄ powder.

According to some embodiments of the present disclosure, a concentration of CuI dispersed in the dichloromethane solution is in a range of 2-5 mmol L⁻¹, and preferably 2.6 mmol L⁻¹. In some embodiments, a concentration of triphenylphosphine in the first mixture is in a range of 1-5 mmol L⁻¹, and preferably 2.0 mmol L⁻¹.

According to the present disclosure, in some embodiments, the ultrasonic dispersion is performed with an ultrasonic frequency of 30-50 kHz and an ultrasonic power of 80 W, and the ultrasonic dispersion is performed for 20-30 min.

According to the present disclosure, in one embodiment, the process for preparing Cu₄I₄ comprises the following steps:
dispersing CuI in a dichloromethane solution, and stirring for 10 min; adding triphenylphosphine thereto, and fully stirring at room temperature for 2 h, to obtain a first mixture; and subjecting the first mixture to suction filtration to obtain a white powdery solid; adding the white powdery solid into an excess acetonitrile solution, performing an ultrasonic treatment, removing excess CuI, to obtain a second mixture; subjecting the second mixture to suction filtration, to obtain a crude solid product; and washing the crude solid product with acetonitrile to obtain a first solid powder, i.e., a pure white powdery solid; and dissolving 10 mg of the first solid powder in 2 mL of a dimethyl sulfoxide solution, to obtain a third mixture, adding the third mixture into a diffusion glass tube to obtain an upper layer, and adding dropwise 2 mL of a methanol solution to the upper layer and diffusing for three days, to obtain the Cu₄I₄ powder.

According to the present disclosure, provided is a method for preparing the hydrophobic copper nanoclusters-containing colloidal solution as described above, which comprises the following steps:
(1) preparation of a solution of Cu₄I₄ in dimethyl sulfoxide
weighing a Cu₄I₄ powder, and adding dimethyl sulfoxide to the Cu₄I₄ powder to prepare the solution of Cu₄I₄ in dimethyl sulfoxide;
(2) preparation of an aqueous solution of EuW₁₀
weighing a EuW₁₀ powder, and adding ultrapure water to the EuW₁₀ powder to prepare the aqueous solution of EuW₁₀; and
(3) preparation of the hydrophobic copper nanoclusters-containing colloidal solution
adding the aqueous solution of EuW₁₀ to the solution of Cu₄I₄ in dimethyl sulfoxide and standing to obtain the hydrophobic copper nanoclusters-containing colloidal solution.

In some embodiments, the standing is performed for 1-3 days.

According to the present disclosure, provided is a method for detecting Fe³⁺, comprising using the hydrophobic copper nanoclusters-containing colloidal solution as described above to detect Fe³⁺.

The principle of the present disclosure is as follows:
The Cu₄I₄ prepared according to the present disclosure has no fluorescence when dissolved in dimethyl sulfoxide at room temperature. Through adding poor solvent water thereto, Cu₄I₄ aggregates to form a precipitation state so that an aggregation-induced emission phenomenon occurs. The vibration and rotation of the ligand are well limited by the solvophobic effect and π-π stacking effect so that the electron transfer effect of the ligand to metals is realized, and the copper nanoclusters show remarkable fluorescence properties. After adding EuW₁₀, the aggregation degree of Cu₄I₄ is inhibited to some extent by the electrostatic interaction between EuW₁₀ and Cu₄I₄, so that the system change from the precipitation state to a turbid liquid state, and the turbid liquid state can be stable for more than three days with remarkable fluorescence properties. When a specific metal ion is added thereto, there is a competitive relationship between the metal ion and Cu₄I₄ to absorb energy, which makes Cu₄I₄ unable to absorb enough energy and thus unable to emit fluorescence, which plays a role in detecting the specific metal ion.

The present disclosure has the following outstanding characteristics and beneficial effects.

1. In the present disclosure, Cu₄I₄ and EuW₁₀ are metal clusters, belonging to new inorganic materials with unique properties. An assembly with an ordered structure is constructed through the self-assembly of supramolecular, thereby realizing fluorescence emission while retaining the fluorescence properties in a solid state.

2. In the present disclosure, copper nanoclusters in stable mixed solvents can be prepared at different concentrations of Cu₄I₄, and the fluorescence color changes with the different concentrations of Cu₄I₄.

3. In the present disclosure, the hydrophobic copper nanoclusters-containing colloidal solution has a simple preparation method, no pollution, and high selectivity and sensitivity for detecting Fe³⁺, and is highly economical. The detection limit reaches 50 nM, and the detection is convenient. The change in fluorescence intensity can be observed with a portable ultraviolet lamp, which is simple to operate and is easy to realize.

The material characteristics described in the present disclosure are tested by the following methods:

1. Transmission electron microscope (TEM). The structure of fluorescent nanoclusters can be observed by TEM.

2. Scanning electron microscope (SEM). The surface morphology of fluorescent nanoclusters can be observed by SEM.

3. Fluorescence spectrum. The fluorescence intensity of fluorescent nanoclusters can be measured by fluorescence spectrophotometer.

### BRIEF DESCRIPTION OF THE DRAWINGS

FIG. 1 is a molecular simulation diagram of Cu₄I₄ and EuW₁₀ used in the present disclosure.

FIG. 2A shows a TEM image of the hydrophobic copper nanoclusters-containing colloid prepared in Example 1 of the present disclosure, and FIG. 2B shows a TEM image of the hydrophobic copper nanoclusters-containing colloid prepared in Example 2 of the present disclosure.

FIG. 3A shows an SEM image of the hydrophobic copper nanoclusters-containing colloids prepared in Example 1 of the present disclosure, and FIG. 3B shows an SEM image of the hydrophobic copper nanoclusters-containing colloids prepared in Example 2 of the present disclosure.

FIG. 4 shows optical photographs of the hydrophobic copper nanoclusters-containing colloidal samples prepared in Examples 2 to 7 of the present disclosure, in which: (a) represents Example 7, (b) represents Example 6, represents is Example 5, (d) represents Example 4, (e) represents Example 3, and (f) represents Example 2.

FIG. 5 shows an excitation and emission fluorescence spectrogram of the hydrophobic copper nanoclusters-containing colloid prepared in Example 2 of the present disclosure.

FIG. 6 shows fluorescence spectrograms of the hydrophobic copper nanoclusters-containing colloids prepared in Examples 3 to 8 of the present disclosure.

FIG. 7 shows optical photographs of the samples under the irradiation of an ultraviolet lamp with a wavelength of 365 nm in Test Example 1 of the present disclosure after adding different kinds of metal ions with the same concentration (50 μmol mL⁻¹) into the hydrophobic copper nanoclusters-containing colloidal solution prepared in Example 1 of the present disclosure.

FIG. 8 shows fluorescence spectrograms of the hydrophobic copper nanoclusters-containing colloidal solutions prepared in Example 1 of the present disclosure added with different kinds of metal ions with the same concentration (50 μmol mL⁻¹) in Test Example 1 of the present disclosure.

FIG. 9 is a histogram of the fluorescence intensity ratio (I/I₀) at the wavelength of 550 nm of the hydrophobic copper nanoclusters-containing colloidal solution (after adding metal ions (I) and before adding metal ions (I₀)) prepared in Test Example 1 of the present disclosure.

FIG. 10 shows optical photographs of the hydrophobic copper nanoclusters-containing colloidal solutions prepared in Example 1 of the present disclosure with different concentrations of Fe³⁺ under the irradiation of an ultraviolet lamp with a wavelength of 365 nm in Test Example 2 of the present disclosure.

FIG. 11 shows fluorescence spectrograms of the hydrophobic copper nanoclusters-containing colloidal solutions prepared in Example 1 of the present disclosure added with different concentrations of Fe³⁺ in Test Example 2 of the present disclosure.

FIG. 12 is a curve showing the variations of fluorescence intensity ratio (I₀/I) at the wavelength of 550 nm before (I₀) and after (I) adding different concentrations of Fe³⁺ in Test Example 2 of the present disclosure.

FIG. 13 shows an ultraviolet absorption spectrum of Fe³⁺ and an excitation spectrum of the hydrophobic copper nanoclusters-containing colloidal solution in Test Example 2 of the present disclosure.

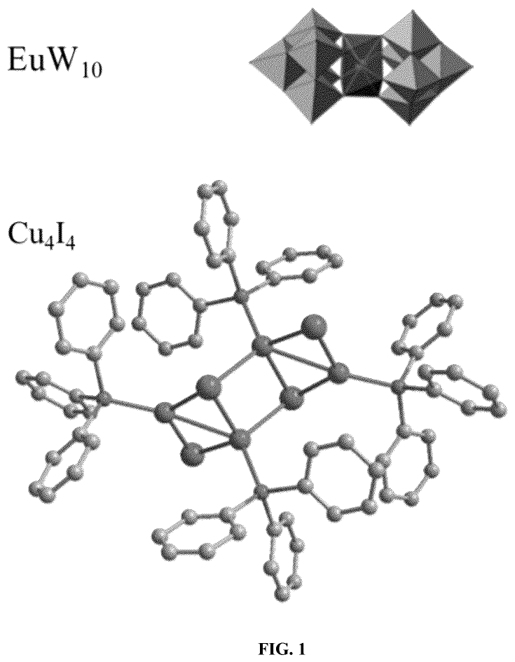

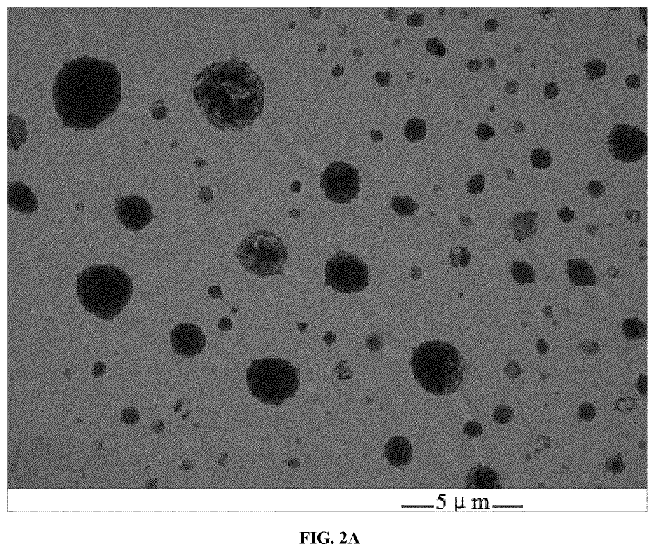

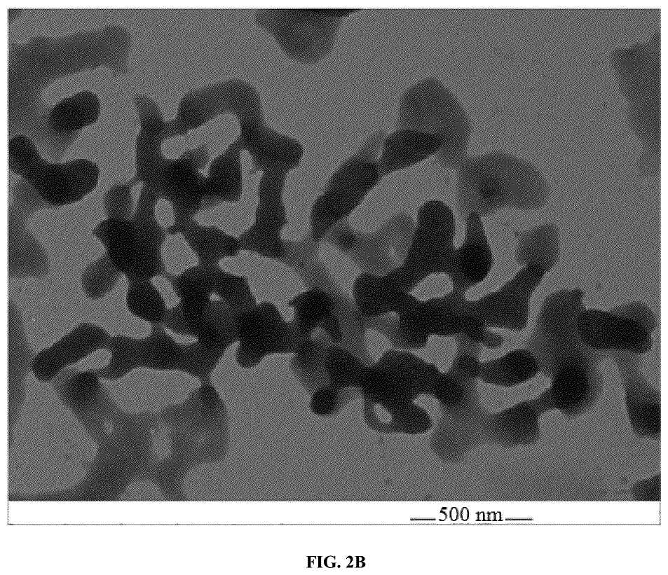

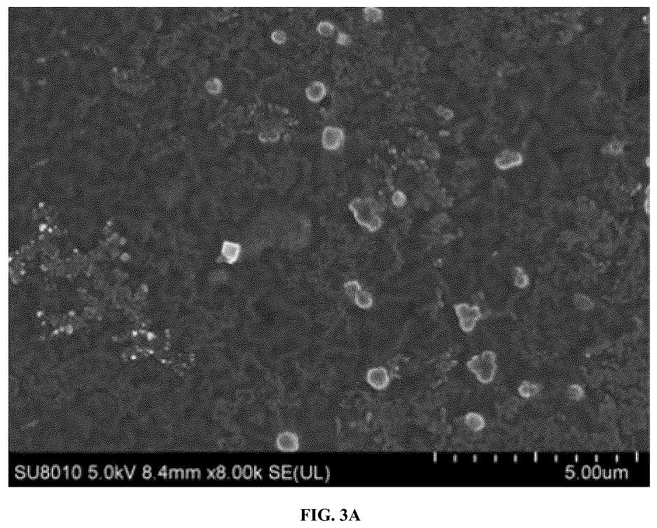

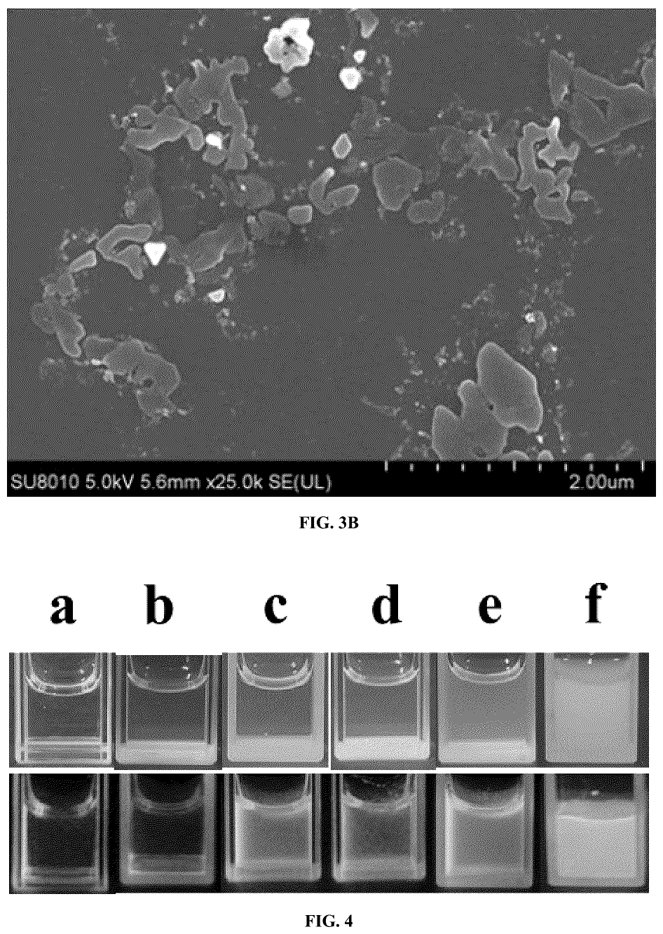

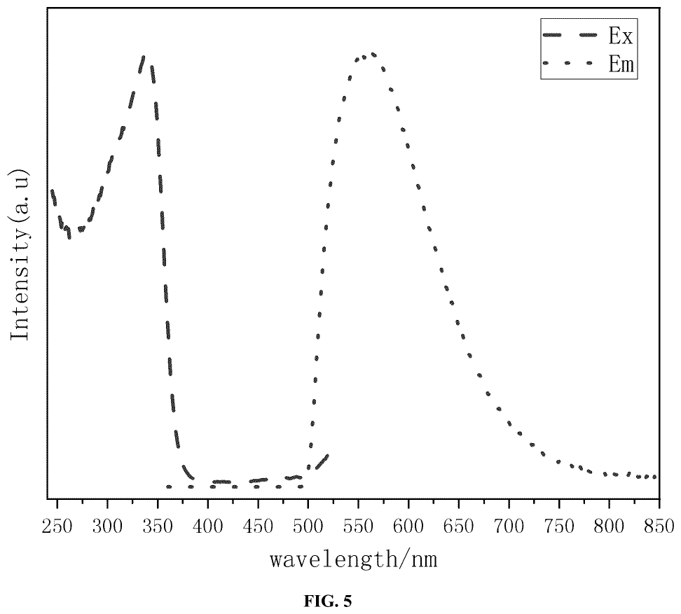

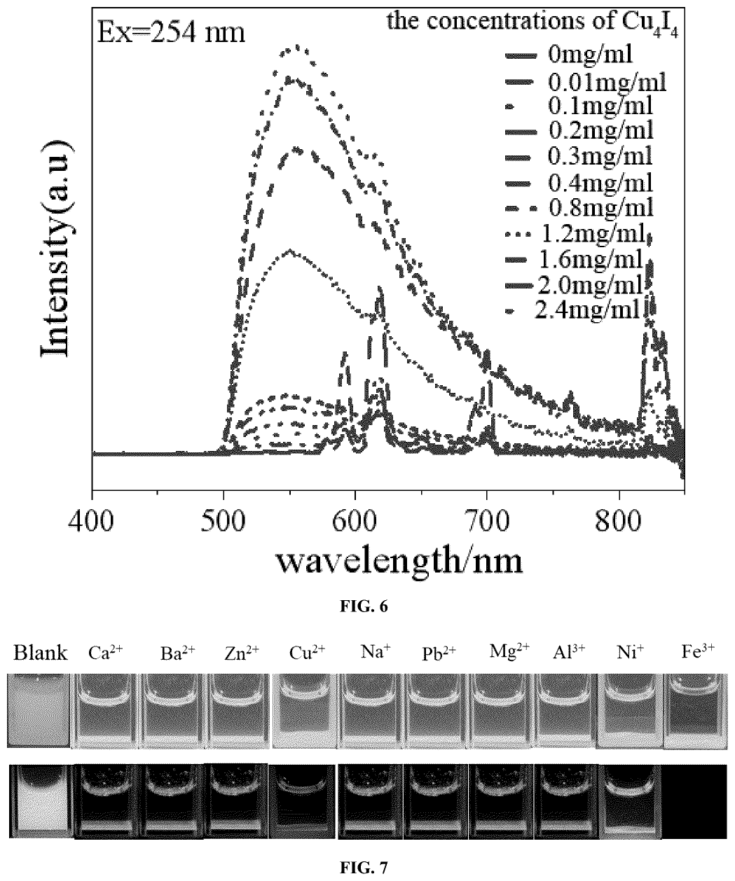

### DETAILED DESCRIPTION OF THE EMBODIMENTS

The present disclosure will be further described with reference to specific examples and the drawings but should not be limited thereto.

The raw materials used in the examples are all conventional raw materials and commercially available products, in which CuI is purchased from Shanghai Zhenxin Reagent Factory, China, triphenylphosphine is purchased from Adamas Reagent Company, all kinds of metal salts are purchased from Tianjin Kemiou Chemical Reagent Co., Ltd., China, and dimethyl sulfoxide i purchased from Sinopharm Group Chemical Reagent Co., Ltd, China.

### Example 1

A method for preparing a hydrophobic copper nanoclusters-containing colloidal solution was performed as follows:

(1) Synthesis of Cu₄I₄

CuI (500 mg, 2.6 mmol) was dispersed in a dichloromethane solution, and they were stirred for 10 min. Triphenylphosphine (524 mg, 2.0 mmol) was added thereto and the resulting mixture was fully stirred at room temperature for 2 h, obtaining a first mixture. The first mixture was subjected to suction filtration, obtaining a white powdery solid. The white powdery solid was added to an excess acetonitrile solution and an ultrasonic treatment was then preformed. The excess CuI was removed, obtaining a second mixture. The second mixture was subjected to suction filtration, obtaining a crude solid product. The crude solid product was washed with acetonitrile, obtaining a first solid powder, i.e., a pure white powdery solid. 10 mg of the pure white solid powder was dissolved in 2 mL of a dimethyl sulfoxide solution, obtaining a third mixture. The third mixture was added to a diffusion glass tube, obtaining an upper layer. 2 mL of a methanol solution was added dropwise to the upper layer. After diffusing for three days, a Cu₄I₄ powder was obtained.

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 4 mg·mL⁻¹.

### (3) Preparation of an Aqueous Solution of EuW₁₀

A EuW₁₀ powder was accurately weight. Ultrapure water was added thereto, preparing an aqueous solution of EuW₁₀ with a concentration of 2.3 mg·mL⁻¹.

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 1.6 mg·mL⁻¹, and the resulting mixture was stood for one day, obtaining the hydrophobic copper nanoclusters-containing colloidal solution.

### Example 2

The method for preparing a hydrophobic copper nanoclusters-containing colloidal solution in this example was preformed according to the procedures as described in Example 1, except that:

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 1.6 mg·mL⁻¹, and the resulting mixture was stood for two days, obtaining the hydrophobic copper nanoclusters-containing colloidal solution.

### Example 3

The method for preparing a hydrophobic copper nanoclusters-containing colloidal solution in this example was preformed according to the procedures as described in Example 2, except that:

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 5 mg·mL⁻¹.

### (4) Preparation of Copper Nanoclusters

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 2.0 mg·mL⁻¹, and the resulting mixture was stood for two days.

### Example 4

The method for preparing a hydrophobic copper nanoclusters-containing colloidal solution in this example was preformed according to the procedures as described in Example 2, except that:

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 1 mg·mL⁻¹.

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 0.4 mg·mL⁻¹, and the resulting mixture was stood for two days.

### Example 5

The method for preparing a hydrophobic copper nanoclusters-containing colloidal solution in this example was preformed according to the procedures as described in Example 2, except that:

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 0.5 mg·mL⁻¹.

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 0.2 mg·mL⁻¹, and the resulting mixture was stood for two days.

### Example 6

The method for preparing a hydrophobic copper nanoclusters-containing colloidal solution in this example was preformed according to the procedures as described in Example 2, except that:

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 0.25 mg·mL⁻¹.

### (4) Preparation of Copper Nanoclusters

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 0.1 mg·mL⁻¹, and the resulting mixture was stood for two days.

### Example 7

The method for preparing a hydrophobic copper nanoclusters-containing colloidal solution in this example was preformed according to the procedures as described in Example 2, except that:

(2) Preparation of Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 0.025 mg·mL⁻¹.

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 0.01 mg·mL⁻¹, and the resulting mixture was stood for two days.

### Example 8

The method for preparing a hydrophobic copper nanoclusters-containing colloidal solution in this example was preformed according to the procedures as described in Example 1, except that:

(2) Preparation of a Solution of Cu₄I₄ in Dimethyl Sulfoxide

The Cu₄I₄ powder was weighed. Dimethyl sulfoxide was added thereto, preparing a solution of Cu₄I₄ in dimethyl sulfoxide with a concentration of 0.0025 mg·mL⁻¹.

### (4) Preparation of a Hydrophobic Copper Nanoclusters-Containing Colloidal Solution

The aqueous solution of EuW₁₀ was taken and added to the solution of Cu₄I₄ in dimethyl sulfoxide (with a volume ratio of the aqueous solution of EuW₁₀ to the solution of Cu₄I₄ in dimethyl sulfoxide being 6:4) such that a total concentration of EuW₁₀ in the final system was 1.38 mg·mL⁻¹ and a total concentration of Cu₄I₄ in the final system was 0.001 mg·mL⁻¹, and the resulting mixture was stood for two days.

### Test Example 1

50 μmol metal ions (Ca²⁺, Fe³⁺, Ba²⁺, Zn²⁺, Cu²⁺, Na⁺, Pb²⁺, Mg²⁺, Al³⁺, Ni²⁺, and K⁺) were weighed and added to the aqueous solution of EuW₁₀ prepared in Example 1, and eddied for 1 min to mix evenly, obtaining a EuW₁₀/metal ion solution.

The prepared EuW₁₀/metal ion solution was transferred to the solution of Cu₄I₄ in dimethyl sulfoxide prepared in Example 1, they were eddied for 10 s to mix evenly, and the resulting mixture was stood for 2 h. The sample was observed under an ultraviolet lamp with a wavelength of 365 nm. The optical photograph is shown in FIG. 7 (the anions countering metal ions were all nitrate).

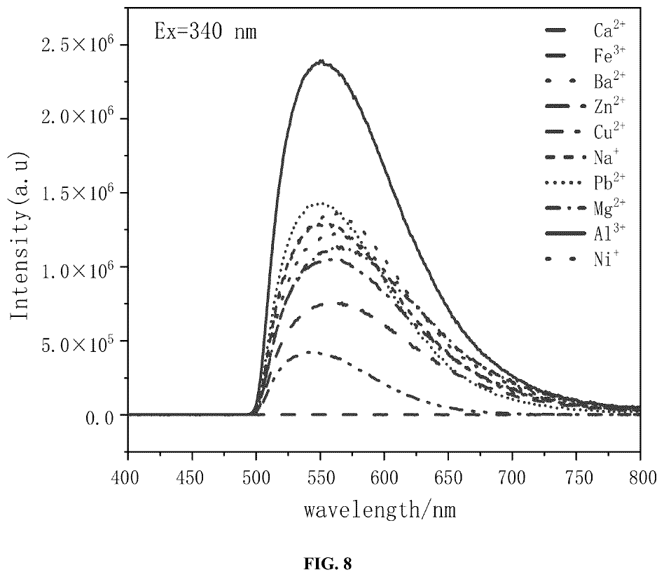

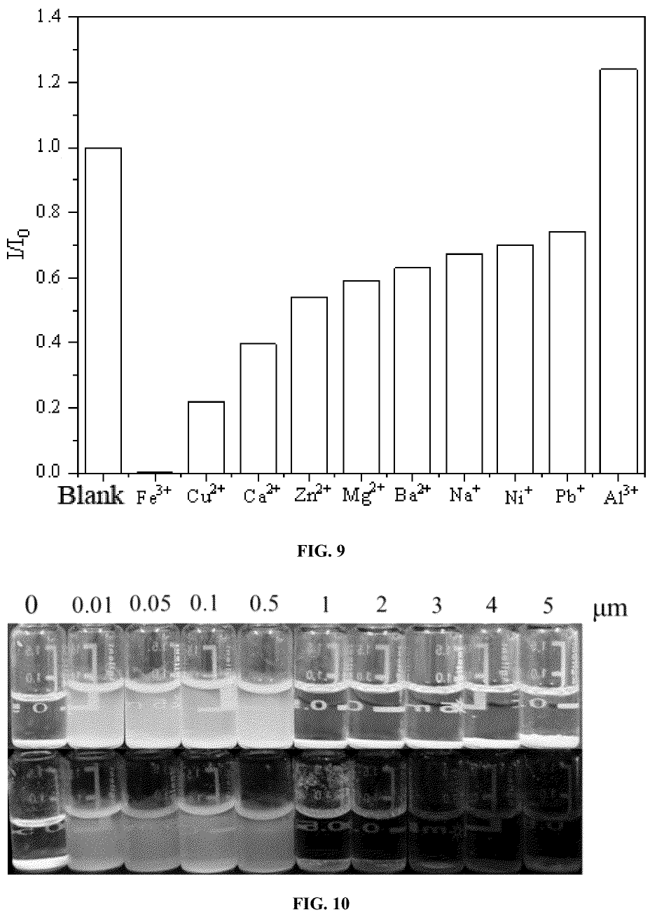

The hydrophobic copper nanoclusters-containing colloidal solution and the samples added with different kinds of metal ions were transferred to quartz colorimetric utensil respectively, and the emission spectrograms of the samples were tested with a fluorescence spectrophotometer. The results are shown in FIG. 8. A histogram of the fluorescence intensity ratio (I/I₀) at the wavelength of 550 nm of the hydrophobic copper nanoclusters-containing colloidal solution after adding metal ions (I) to that before adding metal ions (I₀) is shown in FIG. 9.

Because of the transfer of ligand to metal charge, π-π interaction between ligands, and the addition of poor solvents, Cu₄I₄ molecules aggregates and the aggregation-induced luminescence occurs, so that the aggregations has good fluorescence properties. As can be seen from FIGS. 8 and 9, after adding metal ions, it can be found that only Fe³⁺ can completely quench the fluorescence. The addition of other metal ions has little effect on the fluorescence intensity. It shows that hydrophobic copper nanoclusters-containing colloidal solution prepared according to the present disclosure has high selectivity in detecting Fe³⁺, and the detection limit is 50 nM. This phenomenon can be observed with a portable ultraviolet lamp and fluorescence spectrum. The detection results are easy to observe and determine.

### Test Example 2

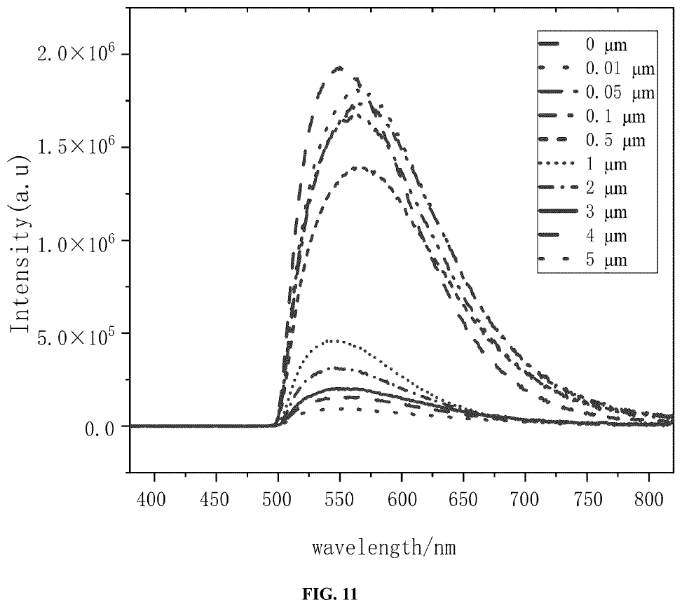

Different amounts of Fe³⁺ were weight and added to the aqueous solution of EuW₁₀ prepared in Example 1 and they were eddied for 1 min to mix evenly, obtaining a EuW₁₀/Fe³⁺ solution. The prepared EuW₁₀/Fe³⁺ solution was transferred to the solution of Cu₄I₄ in dimethyl sulfoxide prepared in Example 1, they were eddied for 1 min to mix evenly, and the resulting mixture was stood for 2 h. FIG. 10 shows an optical photograph of the hydrophobic copper nanoclusters-containing colloidal solution prepared in Example 1 according to the present disclosure with different concentrations of Fe³⁺ under the irradiation of an ultraviolet lamp with a wavelength of 365 nm.

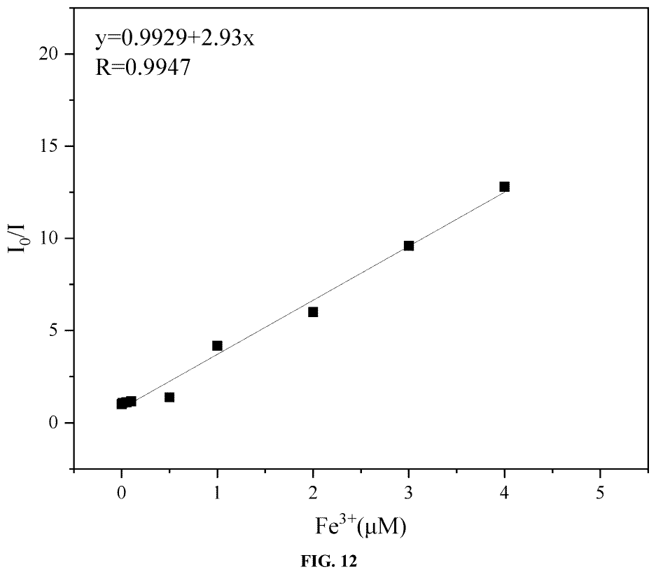

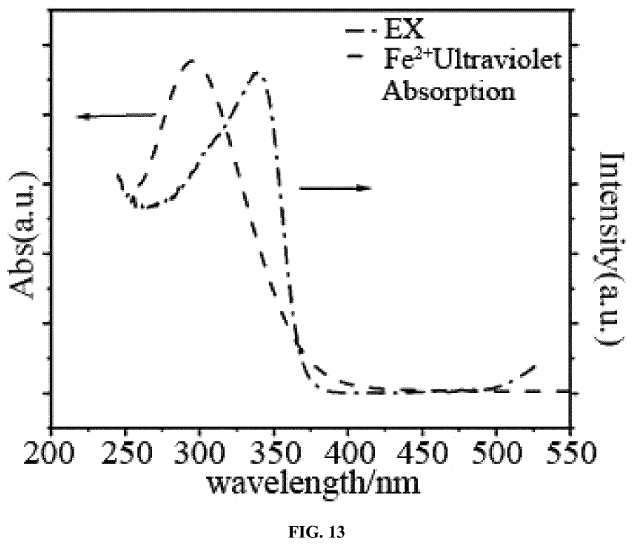

The samples with different concentrations of Fe³⁺ were transferred to a quartz colorimetric utensil, and the emission spectrograms of the samples were tested with a fluorescence spectrophotometer. The results are shown in FIG. 11. A curve showing the variations of fluorescence intensity ratio (I₀/I) at the wavelength of 550 nm of the hydrophobic copper nanoclusters-containing colloidal solution (before adding Fe³⁺ (I₀) and after adding Fe³⁺ (I)) is shown in FIG. 12. An ultraviolet absorption spectrum of Fe³⁺ and an excitation spectrum of the hydrophobic copper nanoclusters-containing colloidal solution are shown in FIG. 13.

It can be seen from FIGS. 11 and 12 that with the increase of the concentration of Fe³⁺, the fluorescence intensity of the hydrophobic copper nanoclusters-containing colloidal solution prepared in Example 1 gradually decreases, and the fluorescence intensity ratio at the wavelength of 550 nm before adding Fe³⁺ (I₀) and after adding Fe³⁺ (I) changes linearly, indicating that the detection of Fe³⁺ has good sensitivity.

1-13. (canceled)

14. A method for preparing a hydrophobic copper nanoclusters-containing colloidal solution, comprising:
mixing a solution of Cu₄I₄ in an organic solvent with an aqueous solution of EuW₁₀ to obtain the hydrophobic copper nanoclusters-containing colloidal solution.

15. The method of claim 14, wherein a volume ratio of the solution of Cu₄I₄ in the organic solvent to the aqueous solution of EuW₁₀ is in a range of (3-5):6.

16. The method of claim 14, wherein the organic solvent is dimethyl sulfoxide.

17. The method of claim 16, wherein a concentration of Cu₄I₄ in dimethyl sulfoxide is in a range of 0.0025-5 mg·mL⁻¹.

18. The method of claim 14, wherein a concentration of EuW₁₀ in water is in a range of 2-3 mg·mL⁻¹.

19. The method of claim 14, wherein after mixing, in the hydrophobic copper nanoclusters-containing colloidal solution, a total concentration of EuW₁₀ is in a range of 1-2 mg·mL⁻¹ and a total concentration of Cu₄I₄ is in a range of 0.001-3 mg·mL⁻¹.

20. The method of claim 14, wherein Cu₄I₄ is prepared by a process comprising:
dispersing CuI in a dichloromethane solution, and stirring to be uniform; adding triphenylphosphine thereto, and fully stirring at room temperature, to obtain a first mixture; and subjecting the first mixture to suction filtration to obtain a white powdery solid; and
adding the white powdery solid into an excessive acetonitrile solution, performing ultrasonic treatment to disperse the white powdery solid in the excessive acetonitrile solution to be uniform, removing excessive CuI, to obtain a second mixture, and subjecting the second mixture to suction filtration, to obtain a crude solid product, washing the crude solid product with acetonitrile, to obtain a first solid powder, dissolving the first solid powder in a dimethyl sulfoxide solution, standing for layering to obtain an upper layer, and adding dropwise a methanol solution to the upper layer, and diffusing for three days, to obtain the Cu₄I₄ powder.

21. The method of claim 20, wherein a concentration of CuI dispersed in the dichloromethane solution is in a range of 2-5 mmol L⁻¹, and a concentration of triphenylphosphine in the first mixture is in a range of 1-5 mmol L⁻¹.

22. The method of claim 20, wherein the ultrasonic dispersion is performed with an ultrasonic frequency of 30-50 kHz and an ultrasonic power of 80 W, and the ultrasonic dispersion is performed for 20-30 min.

23. The method of claim 20, wherein the process for preparing Cu₄I₄ comprises the following steps:
dispersing CuI in the dichloromethane solution, and stirring for 10 min; adding triphenylphosphine thereto, and fully stirring at room temperature for 2 h, to obtain the first mixture; and subjecting the first mixture to suction filtration to obtain the white powdery solid;
adding the white powdery solid into the excess acetonitrile solution, performing the ultrasonic treatment, removing excess CuI, to obtain the second mixture; subjecting the second mixture to suction filtration, to obtain the crude solid product; washing the crude solid product with acetonitrile to obtain the first solid powder, i.e., a pure white powdery solid; and dissolving 10 mg of the first solid powder in 2 mL of the dimethyl sulfoxide solution, to obtain the third mixture, adding the third mixture into the diffusion glass tube to obtain the upper layer, and adding dropwise 2 mL of the methanol solution to the upper layer, and diffusing for three days, to obtain the Cu₄I₄ powder.

24. The method of claim 14, wherein the method comprises:
(1) preparation of a solution of Cu₄I₄ in dimethyl sulfoxide
weighing a Cu₄I₄ powder, and adding dimethyl sulfoxide to the Cu₄I₄ powder to prepare the solution of Cu₄I₄ in dimethyl sulfoxide;
(2) preparation of an aqueous solution of EuW₁₀
weighing a EuW₁₀ powder, and adding ultrapure water to the EuW₁₀ powder to prepare the aqueous solution of EuW₁₀; and
(3) preparation of the hydrophobic copper nanoclusters-containing colloidal solution
adding the aqueous solution of EuW₁₀ to the solution of Cu₄I₄ in dimethyl sulfoxide and standing to obtain the hydrophobic copper nanoclusters-containing colloidal solution.

25. The method of claim 24, wherein the standing is performed for 1-3 days.

26. A method for detecting Fe³⁺, comprising using the hydrophobic copper nanoclusters-containing colloidal solution prepared by the method of claim 1 to detect Fe³⁺.
